(19) United States
(12) Patent Application Publication
(10) Pub. No.: US 2021/0286217 A1
(43) Pub. Date: Sep. 16, 2021

(54) ARRAY SUBSTRATE AND LIQUID CRYSTAL DISPLAY

(71) Applicant: WUHAN CHINA STAR OPTOELECTRONICS TECHNOLOGY CO., LTD., Wuhan, Hubei (CN)

(72) Inventor: Chuan WANG, Wuhan, Hubei (CN)

(21) Appl. No.: 16/626,547

(22) PCT Filed: Mar. 19, 2019
(86) PCT No.: PCT/CN2019/078796

§ 371 Date: Dec. 25, 2019

(30) Foreign Application Priority Data
Sep. 7, 2018 (CN) 201811041370.4

(51) Int. Cl. G02F 1/1343

(52) U.S. Cl. CPC G02F 1/134363; G02F 1/13685

(57) ABSTRACT

An array substrate is provided. The array substrate includes: a plurality of pixel units arranged in an array. Each pixel unit correspondingly includes: a first electrode layer disposed on a glass substrate; a dielectric layer disposed on a surface of the first electrode layer; and a second electrode layer disposed on a surface of the dielectric layer. The second electrode layer includes a patterned electrode pattern. The electrode pattern includes a main electrode pattern and at least one auxiliary electrode pattern correspondingly on at least one side of the main electrode pattern, the at least one auxiliary electrode pattern is electrically connected to the first electrode layer correspondingly through at least one via.

### FIELD OF INVENTION

The present disclosure relates to a technical field of displays, and more particularly to an array substrate and a liquid crystal display having the array substrate.

### BACKGROUND OF INVENTION

Currently, liquid crystal display (LCD) devices have been widely used as display components of electronic equipment for various electronic products. A thin film transistor-liquid crystal display (TFT-LCD) is one component of the most important components in an LCD device.

As described with reference to FIG. 1 of the drawings of the present disclosure, an existing array substrate includes: a plurality of thin film transistors (TFTs). Main components are a backlight, a polarizing plate, an array substrate, a color film substrate, and liquid crystals. As illustrated in FIG. 1, each pixel unit of a plurality of pixel units is correspondingly formed by a glass substrate 101, a blocking layer 102, and a buffer layer 103. Polysilicon 104 is interposed between the buffer layer 103 and a gate insulating layer 105. An interlayer insulating layer 106 is directly formed on the polysilicon 104. A source or drain electrode 109 is a U-shaped structure and is formed between the interlayer insulating layer 107 and a planarization layer 108. A first electrode layer 110 and a second electrode layer 111 are connected by a dielectric layer 112. The gate electrode 106 is a switch electrode. The insulating layer 105 is configured to separate the gate electrode 106 from the source or drain electrode 109 and a signal line. A scan line is connected to the gate electrode 106 of one TFT of the TFTs. The scan line controls one row of the TFTs to be turned on or off. One source or drain electrode 109 of the one TFT of the TFTs is connected to the signal line, and another source or drain electrode 109 is connected to a pixel electrode. When the one TFT of the TFTs is turned on, a signal to the drain electrode 109 through the signal line is transmitted to the source electrode 109 through the one TFT of the TFTs, and is applied to the liquid crystals of the pixel electrode, to control a twist of the liquid crystals. A wire electrode is connected to an edge of the array substrate, and a module component such as a driving circuit.

A TFT substrate is the array substrate. Under control of a clock signal, a capacitor formed by the second electrode layer 110 and the first electrode layer 111 in one pixel unit of the pixel units is charged.

In an existing charging method, a plurality of rotation directions correspondingly of the liquid crystals between the TFT substrate and the color film substrate are not changed by an electric field between the second electrode layer 110 and the first electrode layer 111. Therefore, a polarization direction of light is changed. In this way, a plurality of amounts of light correspondingly emitted from a plurality of different pixel units are controlled, thereby correspondingly achieving different display effects.

In summary, an existing TFT-LCD has a problem of short charging time.

### SUMMARY OF INVENTION

An embodiment of the present disclosure provides an array substrate. By adding a layer of transparent electrodes beside a top transparent electrode, and forming a connection from the layer of the transparent electrodes, through a passivation layer hole, to a bottom transparent electrode, capacitance between the top transparent electrode and the bottom transparent electrode is reduced. Therefore, a technical problem that an existing thin film transistor (TFT) has a longer charging time and low charging efficiency is solved.

In order to solve the aforementioned problem, the present disclosure provides the following technical solutions.

An array substrate includes: a plurality of pixel units arranged in an array. Each pixel unit correspondingly includes: a first electrode layer disposed on a glass substrate; a dielectric layer disposed on a surface of the first electrode layer; and a second electrode layer disposed on a surface of the dielectric layer. The second electrode layer includes a patterned electrode pattern. The electrode pattern includes a main electrode pattern and at least one auxiliary electrode pattern correspondingly on at least one side of the main electrode pattern. The at least one auxiliary electrode pattern is electrically connected to the first electrode layer correspondingly through at least one via. A parallel electric field is formed between the at least one auxiliary electrode pattern and the main electrode pattern to drive a plurality of liquid crystals to rotate.

In the array substrate of the embodiment of the present disclosure, the main electrode pattern and the first electrode layer form an overlap area and at least one non-overlap area, and the at least one auxiliary electrode pattern correspondingly correspond to the at least one non-overlap area, and is spaced apart from the main electrode pattern.

In the array substrate of the embodiment of the present disclosure, the array substrate further includes: a plurality of TFTs arranged in an array, the dielectric layer has a plurality of first vias formed therethrough, the at least one auxiliary electrode pattern is connected to the first electrode layer correspondingly through at least one first via of the first vias, and the main electrode pattern is connected to a drain of one TFT of the TFTs through another first via of the first vias.

In the array substrate of the embodiment of the present disclosure, a plurality of the auxiliary electrode patterns correspondingly correspond to a plurality of the non-overlap areas and spaced apart from each other, and each auxiliary electrode pattern correspondingly correspond to at least one first via of the first vias.

In the array substrate of the embodiment of the present disclosure, a second via is formed through the first electrode layer, the second via has a hole size larger than a hole size of the other first via of the first vias, and the other first via of the first vias is embedded in the overlap area corresponding to the second via, so that the main electrode pattern corresponding to the other first via of the first vias is insulated from the first electrode layer by the dielectric layer.

In the array substrate of the embodiment of the present disclosure, the at least one auxiliary electrode pattern is equidistantly disposed from the main electrode pattern.

In the array substrate of the embodiment of the present disclosure, the main electrode pattern and the first electrode layer are correspondingly connected to a plurality of metal lines of the TFT, to form a voltage difference to drive the liquid crystals to rotate.

In the array substrate of the embodiment of the present disclosure, at least one corresponding first via of the first vias is formed in the dielectric layer.

In the array substrate of the embodiment of the present disclosure, the at least one auxiliary electrode pattern and the main electrode pattern are formed by a same manufacturing process, and both the at least one auxiliary electrode pattern and the main electrode pattern are made of indium tin oxide (ITO).

An embodiment of the present disclosure also provides an array substrate. The array substrate includes a plurality of pixel units arranged in an array. Each pixel unit correspondingly includes:

a first electrode layer disposed on a glass substrate;

a dielectric layer disposed on a surface of the first electrode layer; and

a second electrode layer disposed on a surface of the dielectric layer, wherein the second electrode layer includes a patterned electrode pattern.

The electrode pattern includes a main electrode pattern and at least one auxiliary electrode pattern correspondingly on at least one side of the main electrode pattern, the at least one auxiliary electrode pattern is electrically connected to the first electrode layer correspondingly through at least one via, and a parallel electric field is formed between the at least one auxiliary electrode pattern and the main electrode pattern to drive a plurality of liquid crystals to rotate.

The at least one auxiliary electrode pattern is equidistantly disposed from the main electrode pattern.

The main electrode pattern and the first electrode layer are correspondingly connected to a plurality of metal lines of the TFT, to form a voltage difference to drive the liquid crystals to rotate.

In the array substrate of the embodiment of the present disclosure, the main electrode pattern and the first electrode layer form an overlap area and at least one non-overlap area, and the at least one auxiliary electrode pattern correspondingly correspond to the at least one non-overlap area, and is spaced apart from the main electrode pattern.

In the array substrate of the embodiment of the present disclosure, the array substrate further includes: a plurality of TFTs arranged in an array, the dielectric layer has a plurality of first vias formed therethrough, the at least one auxiliary electrode pattern is connected to the first electrode layer correspondingly through at least one first via of the first vias, and the main electrode pattern is connected to a drain of one TFT of the TFTs through another first via of the first vias.

In the array substrate of the embodiment of the present disclosure, a plurality of the auxiliary electrode patterns correspondingly correspond to a plurality of the non-overlap areas and spaced apart from each other, and each auxiliary electrode pattern correspondingly correspond to at least one first via of the first vias.

In the array substrate of the embodiment of the present disclosure, a second via is formed through the first electrode layer, the second via has a hole size larger than a hole size of the other first via of the first vias, and the other first via of the first vias is embedded in the overlap area corresponding to the second via, so that the main electrode pattern corresponding to the other first via of the first vias is insulated from the first electrode layer by the dielectric layer.

In the array substrate of the embodiment of the present disclosure, at least one corresponding first via of the first vias is formed in the dielectric layer.

In the array substrate of the embodiment of the present disclosure, the at least one auxiliary electrode pattern and the main electrode pattern are formed by a same manufacturing process, and both the at least one auxiliary electrode pattern and the main electrode pattern are made of ITO.

An embodiment of the present disclosure provides a liquid crystal display (LCD). The LCD includes an array substrate. The array substrate includes: a plurality of pixel units arranged in an array. Each of the pixel units correspondingly includes:

a first electrode layer disposed on a glass substrate;

a dielectric layer disposed on a surface of the first electrode layer; and

a second electrode layer disposed on a surface of the dielectric layer, wherein the second electrode layer includes a patterned electrode pattern.

The electrode pattern includes a main electrode pattern and at least one auxiliary electrode pattern correspondingly on at least one side of the main electrode pattern, the at least one auxiliary electrode pattern is electrically connected to the first electrode layer correspondingly through at least one via, and a parallel electric field is formed between the at least one auxiliary electrode pattern and the main electrode pattern to drive a plurality of liquid crystals to rotate.

Advantages of the present disclosure are as follows: The electrode pattern includes the main electrode pattern and the at least one auxiliary electrode pattern correspondingly on the at least one side of the main electrode pattern, and the at least one auxiliary electrode pattern is electrically connected to the first electrode layer correspondingly through the at least one via. Therefore, capacitance between the at least one auxiliary electrode pattern and the main electrode pattern is reduced, charging time of each pixel unit is reduced, and work efficiency is improved.

### DESCRIPTION OF DRAWINGS

In order to describe a technical solution in embodiments or existing technology more clearly, drawings required to be used by the embodiments are briefly introduced below. Obviously, the drawings in the description below are only some embodiments of the present disclosure. With respect to persons of ordinary skill in the art, under a premise that inventive efforts are not made, other drawings may be obtained based on these drawings.

FIG. 1 is a schematic diagram of a substrate structure of an existing array substrate.

FIG. 2 is a schematic diagram of a substrate structure of an array substrate in accordance with a first embodiment of the present disclosure.

FIG. 3 is a schematic diagram of a cross-sectional substrate structure of the array substrate in accordance with the first embodiment of the present disclosure.

FIG. 4 is a top-view diagram of a single pixel unit of the array substrate in accordance with the first embodiment of the present disclosure.

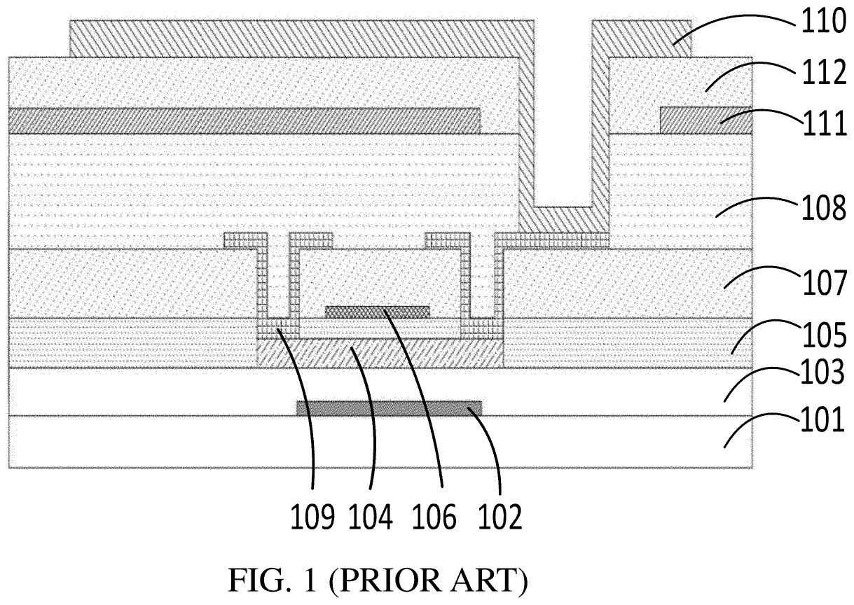

### DETAILED DESCRIPTION OF PREFERRED EMBODIMENTS

Technical solutions in the embodiments of the present disclosure are clearly and completely described below in conjunction with the drawings in the embodiments of the present disclosure. Obviously, the described embodiments are only a portion of the embodiments of the present disclosure, not all of the embodiments. Based on the embodiments of the present disclosure, other embodiments obtained under a premise that inventive efforts are not made by persons of ordinary skill in the art are within the protection scope of the present disclosure.

In the present disclosure, unless otherwise definitely specified and defined, when a first feature is “over” or “under” a second feature, the first feature may be directly in contact with the second feature, or the first feature and the second feature may not be directly in contact with each other and may be in contact through another feature between the first feature and the second feature. Furthermore, when the first feature is “over”, “above”, or “upper than” the second feature, the first feature may be directly above or obliquely above the second feature, or the phrase may merely mean that a level of the first feature is higher than a level of the second feature. When the first feature is “under”, “below”, or “lower than” the second feature, the first feature may be directly below or obliquely below the second feature, or the phrase may merely mean that a level of the first feature is lower than a level of the second feature.

The publication of the following description provides many different embodiments or examples for implementing different structures of the present disclosure. In order to simplify the publication of the present disclosure, in the following description, components and configurations of particular examples are described. Of course, they are only examples, and do not aim at limiting the present disclosure. In addition, the present disclosure may repeat reference numerals and/or reference letters in different examples. The repetition is for the purposes of simplicity and clarity, and the repetition itself does not indicate relationships between methods and/or configurations of various embodiments. Furthermore, the present disclosure provides various particular process and material examples, but those of ordinary skill in the art may think of application of other processes and/or use of other material.

Duration of a charging time of each pixel unit of a plurality pixel units of an array substrate is related to capacitance formed by a second electrode layer and a first electrode layer. In an RC series circuit, where R is a resistor, and C is a capacitor, a charging time of the capacitor is calculated by the following equation: Charging time T=R*C*In((E-V)/E), where R is an equivalent resistance of the circuit, C is capacitance, a value of an externally applied voltage of the RC series circuit, T is the charging time, V is a voltage to be reached by the capacitor, and In is a natural log. The larger the capacitance C is, the longer the charging time is. The smaller the capacitance C is, the shorter the charging time is. The smaller the capacitance C or the resistance R is, the smaller a time constant R*C is. The smaller the time constant R*C is, the faster charging speed and discharging speed are, and vice versa. Capacitors are used in almost all electronic circuits. Capacitors can serve as quick batteries.

An array substrate is a type of insulated gate field effect transistor, and is equivalent to a transistor circuit. A gate electrode is connected to a gate line, a source electrode is connected to a signal line, and a drain electrode is connected to a pixel electrode. Liquid crystal materials belong to an insulator and usually has a low electrical conductivity. The pixel electrode in the array substrate and a common electrode on a color film substrate form two electrodes correspondingly on two ends of the liquid crystal materials. Hence, a pixel electrode portion of a liquid crystal panel is equivalent to a capacitor. At the same time, a storage capacitor is formed by the pixel electrode and the gate electrode correspondingly being two storage capacitor electrodes at the same time and separated by an insulating film. The storage capacitor is in parallel with the liquid crystal capacitor. Therefore, a single pixel of an active matrix liquid crystal display (LCD) is equivalent to an equivalent circuit including a transistor switch connected to a parallel-connected liquid crystal capacitor and storage capacitor. The liquid crystal capacitor includes a second electrode layer and a first electrode layer. The second electrode layer and the first electrode layer account for 80% to 90% of capacitance of the pixel unit. Therefore, increasing capacitance of the first electrode layer and the second electrode layer increases a charging time of the pixel unit.

Control of the switch is connected to the gate line. When the gate electrode of the array substrate is selected by scanning, a positive high pulse is applied to the gate electrode, and the array substrate conducts. A signal is input to the source electrode. After an image signal is transmitted to the first electrode layer and the second electrode layer connected to the conducting array substrate using an ON-state current of the conducting array substrate, the first electrode layer and the second electrode layer are charged at the same time, and a signal voltage is stored in the first electrode layer and the second electrode layer. The signal voltage of the liquid crystal pixel drives liquid crystal molecules to rotate, realizing display. The liquid crystal capacitor functions to maintain image display.

### First Embodiment

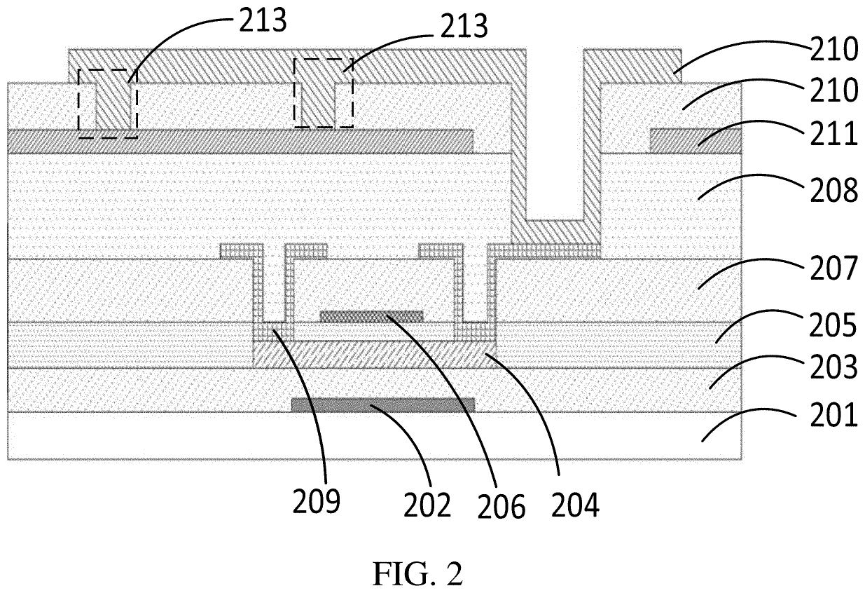

As illustrated in FIG. 2, each pixel unit of a plurality of pixel units is correspondingly formed by a glass substrate 201, a blocking layer 202, and a buffer layer 203. Polysilicon 204 is interposed between the buffer layer 203 and a gate insulating layer 205. An interlayer insulating layer 206 is directly formed on the polysilicon 204. A source or drain electrode 209 is a U-shaped structure and is formed between the interlayer insulating layer 207 and a planarization layer 208. A first electrode layer 210 and a second electrode layer 211 are connected by a dielectric layer 212. In the dielectric layer 212, at least one corresponding first via 212 is included for decreasing capacitance between the first electrode layer 210 and the second electrode layer 211. This capacitance forms an electric field controlling rotation of liquid crystals. The gate electrode 206 is a switch electrode. The insulating layer 205 is configured to separate the gate electrode 206 from the source or drain electrode 209 and a signal line. A scan line is connected to the gate electrode 206 of one TFT of the TFTs. The scan line controls one row of the TFTs to be turned on or off. One source or drain electrode 209 of the one TFT of the TFTs is connected to the signal line, and another source or drain electrode 109 is connected to a pixel electrode. When the one TFT of the TFTs is turned on, a signal to the drain electrode 209 through the signal line is transmitted to the source electrode 209 through the one TFT of the TFTs, and is applied to the liquid crystals of the pixel electrode, to control a twist of the liquid crystals. A wire electrode is connected to an edge of the array substrate, and a module component such as a driving circuit.

A TFT substrate is the array substrate. Under control of a clock signal, a capacitor formed by the second electrode layer 210 and the first electrode layer 211 in one pixel unit of the pixel units is charged.

An essential difference between FIG. 2 and the related art is that the at least one first via 213 is formed in the dielectric layer 212, thereby reducing an electric field controlling rotation of liquid crystals.

In the array substrate of the embodiment of the present disclosure, a cross-sectional shape of each first via of the at least one first via 213 is a circle or a rectangle, to facilitate connection.

As illustrated in FIG. 3, the second electrode layer includes a main electrode pattern 310 and a plurality of auxiliary electrode patterns 313. An electric field between the main electrode pattern 310 and the second auxiliary electrode patterns 313 are equivalently a capacitor structure configured to control capacitance needed for rotating liquid crystals. Capacitance between the main electrode pattern 310 and the first electrode layer 311 are divided into two portions: capacitance between the main electrode pattern 310 and the first electrode layer 311 directly under the main electrode pattern 310, and capacitance correspondingly between a plurality of edges of the main electrode pattern 310 and the first electrode layer 311. The capacitance between the main electrode pattern 310 and the first electrode layer 311 is a sum of the above two portions of the capacitance. By adding a layer of first auxiliary electrode patterns 314 beside the main electrode pattern 310, wherein electrical connection between the second auxiliary electrode patterns 313 and the main electrode pattern is via connection, a distance between the first electrode layer 311 and the main electrode pattern 310 is reduced. Therefore, the capacitance between the main electrode pattern 310 and the first electrode layer 311 is decreased. Hence, the charging time of the one pixel unit of the pixel units is reduced.

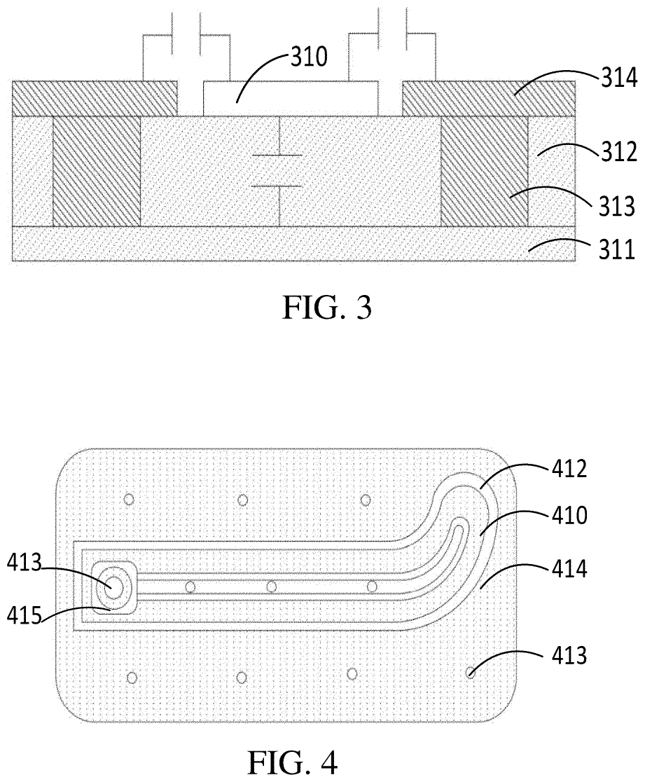

FIG. 4 is a schematic top-view diagram of a single pixel unit of FIG. 3. In the present embodiment, the layer of the first auxiliary electrode patterns 414 is newly added beside the main electrode pattern 410, and is connected to the first electrode layer 411 through the second auxiliary electrode patterns 413. The main electrode pattern 410 connects the main electrode pattern 410 to the first electrode layer 411. The auxiliary electrode patterns and the main electrode pattern are formed by a same manufacturing process, and both the auxiliary electrode patterns and the main electrode pattern are made of indium tin oxide (ITO). The auxiliary electrode patterns 423 are interposed between the first electrode layer 411 and the top transparent 410, thereby realizing an object of reducing the capacitance between the main electrode pattern 410 and the first electrode layer 411, and decreasing the charging time of the one pixel unit of the pixel units. In the array substrate of the embodiment of the present disclosure, in the present embodiment, a planarization layer hole 415 may also be disposed beside the first electrode layer 411, thereby facilitating connecting the main electrode pattern 410 to the first electrode layer 411.

In the array substrate of the embodiment of the present disclosure, the main electrode pattern 410 are evenly distributed on one end of the second electrode layer 410.

In the present embodiment, the pixel sequence may also be an organic light emitting diode (OLED) array, a quantum dot light emitting diode (QLED) array, or a micro light emitting diode (LED) array.

Advantages are as follows: By adding a layer of the main electrode pattern beside the second electrode layer, and connecting the layer of the main electrode pattern to the first electrode layer through the auxiliary electrode patterns, the capacitance between the first electrode layer and the second electrode layer is reduced. Therefore, the charging time of the one pixel unit of the pixel units is reduced, and work efficiency is improved.

In summary, although the present disclosure has been described with preferred embodiments thereof above, it is not intended to be limited by the foregoing preferred embodiments. Persons skilled in the art can carry out many changes and modifications to the described embodiments without departing from the scope and the spirit of the present disclosure. Therefore, the protection scope of the present disclosure is in accordance with the scope defined by the claims.

What is claimed is:

1. An array substrate, comprising: a plurality of pixel units arranged in an array, wherein each pixel unit correspondingly comprises:
a first electrode layer disposed on a glass substrate;
a dielectric layer disposed on a surface of the first electrode layer; and
a second electrode layer disposed on a surface of the dielectric layer, wherein the second electrode layer comprises a patterned electrode pattern;
wherein the electrode pattern comprises a main electrode pattern and at least one auxiliary electrode pattern correspondingly on at least one side of the main electrode pattern, the at least one auxiliary electrode pattern is electrically connected to the first electrode layer correspondingly through at least one via, and a parallel electric field is formed between the at least one auxiliary electrode pattern and the main electrode pattern to drive a plurality of liquid crystals to rotate;
wherein the at least one auxiliary electrode pattern is equidistantly disposed from the main electrode pattern; and
wherein the main electrode pattern and the first electrode layer are correspondingly connected to a plurality of metal lines of the thin film transistor (TFT), to form a voltage difference to drive the liquid crystals to rotate.

2. The array substrate of claim 1, wherein the main electrode pattern and the first electrode layer form an overlap area and at least one non-overlap area, and the at least one auxiliary electrode pattern correspondingly correspond to the at least one non-overlap area, and is spaced apart from the main electrode pattern.

3. The array substrate of claim 2, wherein the array substrate further comprises: a plurality of TFTs arranged in an array, the dielectric layer has a plurality of first vias formed therethrough, the at least one auxiliary electrode pattern is connected to the first electrode layer correspondingly through at least one first via of the first vias, and the main electrode pattern is connected to a drain of one TFT of the TFTs through another first via of the first vias.

4. The array substrate of claim 2, wherein a plurality of the auxiliary electrode patterns correspondingly correspond to a plurality of the non-overlap areas and spaced apart from each other, and each auxiliary electrode pattern correspondingly correspond to at least one first via of the first vias.

5. The array substrate of claim 2, wherein a second via is formed through the first electrode layer, the second via has a hole size larger than a hole size of the other first via of the first vias, and the other first via of the first vias is embedded in the overlap area corresponding to the second via, so that the main electrode pattern corresponding to the other first via of the first vias is insulated from the first electrode layer by the dielectric layer.

6. The array substrate of claim 1, wherein at least one corresponding first via of the first vias is formed in the dielectric layer.

7. The array substrate of claim 1, wherein the at least one auxiliary electrode pattern and the main electrode pattern are formed by a same manufacturing process, and both the at least one auxiliary electrode pattern and the main electrode pattern are made of indium tin oxide (ITO).

8. An array substrate, comprising: a plurality of pixel units arranged in an array, wherein each pixel unit correspondingly comprises:
a first electrode layer disposed on a glass substrate;
a dielectric layer disposed on a surface of the first electrode layer; and
a second electrode layer disposed on a surface of the dielectric layer, wherein the second electrode layer comprises a patterned electrode pattern;
wherein the electrode pattern comprises a main electrode pattern and at least one auxiliary electrode pattern correspondingly on at least one side of the main electrode pattern, the at least one auxiliary electrode pattern is electrically connected to the first electrode layer correspondingly through at least one via, and a parallel electric field is formed between the at least one auxiliary electrode pattern and the main electrode pattern to drive a plurality of liquid crystals to rotate.

9. The array substrate of claim 8, wherein the main electrode pattern and the first electrode layer form an overlap area and at least one non-overlap area, and the at least one auxiliary electrode pattern correspondingly correspond to the at least one non-overlap area, and is spaced apart from the main electrode pattern.

10. The array substrate of claim 9, wherein the array substrate further comprises: a plurality of thin film transistors (TFTs) arranged in an array, the dielectric layer has a plurality of first vias formed therethrough, the at least one auxiliary electrode pattern is connected to the first electrode layer correspondingly through at least one first via of the first vias, and the main electrode pattern is connected to a drain of one TFT of the TFTs through another first via of the first vias.

11. The array substrate of claim 9, wherein a plurality of the auxiliary electrode patterns correspondingly correspond to a plurality of the non-overlap areas and spaced apart from each other, and each auxiliary electrode pattern correspondingly correspond to at least one first via of the first vias.

12. The array substrate of claim 9, wherein a second via is formed through the first electrode layer, the second via has a hole size larger than a hole size of the other first via of the first vias, and the other first via of the first vias is embedded in the overlap area corresponding to the second via, so that the main electrode pattern corresponding to the other first via of the first vias is insulated from the first electrode layer by the dielectric layer.

13. The array substrate of claim 8, wherein the at least one auxiliary electrode pattern is equidistantly disposed from the main electrode pattern.

14. The array substrate of claim 8, wherein the main electrode pattern and the first electrode layer are correspondingly connected to a plurality of metal lines of the TFT, to form a voltage difference to drive the liquid crystals to rotate.

15. The array substrate of claim 8, wherein at least one corresponding first via of the first vias is formed in the dielectric layer.

8. The array substrate of claim 8, wherein the at least one auxiliary electrode pattern and the main electrode pattern are formed by a same manufacturing process, and both the at least one auxiliary electrode pattern and the main electrode pattern are made of indium tin oxide (ITO).

17. A liquid crystal display, comprising: an array substrate, wherein the array substrate comprises: a plurality of pixel units arranged in an array, wherein each pixel unit correspondingly comprises:
a first electrode layer disposed on a glass substrate;
a dielectric layer disposed on a surface of the first electrode layer; and
a second electrode layer disposed on a surface of the dielectric layer, wherein the second electrode layer comprises a patterned electrode pattern;
wherein the electrode pattern comprises a main electrode pattern and at least one auxiliary electrode pattern correspondingly on at least one side of the main electrode pattern, the at least one auxiliary electrode pattern is electrically connected to the first electrode layer correspondingly through at least one via, and a parallel electric field is formed between the at least one auxiliary electrode pattern and the main electrode pattern to drive a plurality of liquid crystals to rotate.
